(19) United States
(12) Patent Application Publication
(10) Pub. No.: US 2023/0237641 A1
(43) Pub. Date: Jul. 27, 2023

(54) INSPECTION SUPPORT DEVICE FOR STRUCTURE, INSPECTION SUPPORT METHOD FOR STRUCTURE, AND PROGRAM

(71) Applicant: FUJIFILM Corporation, Tokyo (JP)

(72) Inventor: Shuhei HORITA, Tokyo (JP)

(73) Assignee: FUJIFILM Corporation, Tokyo (JP)

(21) Appl. No.: 18/193,388

(22) Filed: Mar. 30, 2023

Related U.S. Application Data
(63) Continuation of application No. PCT/JP2021/031985, filed on Aug. 31, 2021.

(30) Foreign Application Priority Data
Oct. 2, 2020 (JP) 2020-167558

(51) Int. Cl. G06T 7/00; G06T 17/20; G06Q 50/08

(52) U.S. Cl. CPC G06T 7/0004; G06T 17/20; G06Q 50/08; G06T 2207/30184

(57) ABSTRACT

Provided are an inspection support device for a structure, an inspection support method for a structure, and a program capable of easily displaying related information from text data included in an inspection record or the like. An inspection support device (10) for a structure including a processor, in which the processor acquires three-dimensional model data (101) of the structure, inspection data (103), and a list of text data of a plurality of inspection points related to an inspection work of the structure, displays the list of text data on a display device (30), receives selection of the text data of at least one inspection point from the displayed list of text data, analyzes the selected text data to extract a corresponding portion (102) on the three-dimensional model data (101) and/or the inspection data (103), which are corresponding to the text data of the inspection point, and displays the extracted corresponding portion (102) on the three-dimensional model data (101) and/or the extracted inspection data (103) on the display device (30).

### CROSS-REFERENCE TO RELATED APPLICATIONS

The present application is a Continuation of PCT International Application No. PCT/JP2021/031985 filed on Aug. 31, 2021 claiming priority under 35 U.S.C § 119(a) to Japanese Patent Application No. 2020-167558 filed on Oct. 2, 2020. Each of the above applications is hereby expressly incorporated by reference, in its entirety, into the present application.

### BACKGROUND OF THE INVENTION

### 1. Field of the Invention

The present invention relates to an inspection support device for a structure, an inspection support method for a structure, and a program.

### 2. Description of the Related Art

There are structures such as a bridge and a tunnel as social infrastructure. Since damage occurs in these structures and the damage has a property of progressing, it is required to perform regular inspections.

An inspector who inspects a structure needs to create an inspection record of a predetermined format, as a form indicating a result of the inspection, based on an inspection procedure determined by a structure manager or the like. With viewing of a damage diagram created in a predetermined format, even an expert who is different from the inspector who actually performs the inspection can grasp a progressing situation of damage to the structure and formulate a maintenance plan for the structure.

Similarly, for a structure such as a condominium or an office building, a state of the structure is also periodically inspected, and repair or mending is performed based on an inspection result. In the inspection, an inspection report is created. Regarding the creation of the inspection report, JP2019-082933A discloses a system capable of reducing a time required for the creation of the inspection report.

### SUMMARY OF THE INVENTION

By the way, in a case where an inspection record is checked, there may be a case where it is desired to refer to damage fact information (captured image, drawing, three-dimensional model data, or the like) related to a damage situation from text information of the inspection record. However, the damage fact information is not associated with the inspection record created in the predetermined format, and thus there is a problem that it takes time and effort to refer to the damage fact information.

The present invention has been made in view of such circumstances, and an object of the present invention is to provide an inspection support device for a structure, an inspection support method for a structure, and a program capable of easily displaying related information from text data included in an inspection record or the like.

An inspection support device for a structure according to a first aspect comprises an inspection support device for a structure including a processor. The processor acquires three-dimensional model data of the structure, inspection data mutually associated with the three-dimensional model data, and a list of text data of a plurality of inspection points related to an inspection work of the structure, displays the list of text data on a display device, receives selection of the text data of at least one inspection point from the displayed list of text data, analyzes the selected text data to extract a corresponding portion on the three-dimensional model data and/or the inspection data, which are corresponding to the text data of the inspection point, and displays the extracted corresponding portion on the three-dimensional model data and/or the extracted inspection data on the display device.

In the inspection support device for a structure according to a second aspect, the processor analyzes the selected text data to extract the corresponding portion on the three-dimensional model data corresponding to the inspection point and extracts the inspection data associated with the extracted corresponding portion on the three-dimensional model data.

In the inspection support device for a structure according to a third aspect, a memory that stores the three-dimensional model data, the inspection data mutually associated with the three-dimensional model data, and the list of text data is further provided, and the processor acquires the three-dimensional model data, the inspection data, and the list of text data from the memory.

In the inspection support device for a structure according to a fourth aspect, the processor maps the extracted inspection data to the three-dimensional model data and displays the mapped data on the display device.

In the inspection support device for a structure according to a fifth aspect, the list of text data is an inspection record.

In the inspection support device for a structure according to a sixth aspect, the three-dimensional model data includes at least a member region and data of a member.

In the inspection support device for a structure according to a seventh aspect, the inspection data includes a plurality of types of data.

In the inspection support device for a structure according to an eighth aspect, the plurality of types of data include a captured image, a panoramic composite image, damage information, and a two-dimensional drawing.

In the inspection support device for a structure according to a ninth aspect, the processor displays at least one type of data on the display device from the plurality of types of data included in the inspection data.

In the inspection support device for a structure according to a tenth aspect, the inspection data includes a plurality of captured images, and the processor displays the captured image satisfying a condition on the display device from the plurality of captured images to be displayed.

In the inspection support device for a structure according to an eleventh aspect, the processor analyzes the selected text data to extract past inspection data corresponding to the inspection point, and displays the extracted past inspection data on the display device.

An inspection support method for a structure according to a twelfth aspect is an inspection support method for a structure with use of an inspection support device for a structure including a processor. The inspection support method for a structure comprises, via the processor, acquiring three-dimensional model data of the structure, inspection data mutually associated with the three-dimensional model data, and a list of text data of a plurality of inspection points related to an inspection work of the structure, displaying the list of text data on a display device, receiving selection of the text data of at least one inspection point from the displayed list of text data, analyzing the selected text data to extract a corresponding portion on the three-dimensional model data and/or the inspection data, which are corresponding to the text data of the inspection point, and displaying the extracted corresponding portion on the three-dimensional model data and/or the extracted inspection data on the display device.

A program according to a thirteenth aspect is a program causing an inspection support device for a structure including a processor to execute an inspection support method for a structure. The program causes the processor to execute acquiring three-dimensional model data of the structure, inspection data mutually associated with the three-dimensional model data, and a list of text data of a plurality of inspection points related to an inspection work of the structure, displaying the list of text data on a display device, receiving selection of the text data of at least one inspection point from the displayed list of text data, analyzing the selected text data to extract a corresponding portion on the three-dimensional model data and/or the inspection data, which are corresponding to the text data of the inspection point, and displaying the extracted corresponding portion on the three-dimensional model data and/or the extracted inspection data on the display device.

With the inspection support device for a structure, the inspection support method for a structure, and the program according to the present invention, it is possible to easily display the related information from the text data included in the inspection record or the like.

### BRIEF DESCRIPTION OF THE DRAWINGS

FIG. 1 is a block diagram showing an example of a hardware configuration of an inspection support device for a structure.

FIG. 2 is a block diagram showing a processing function realized by a CPU.

FIG. 3 is a diagram showing information and the like stored in a storage unit.

FIG. 4 is a flowchart showing an inspection support method with use of the inspection support device for a structure.

FIGS. 5A and 5B are diagrams showing an example of three-dimensional model data. FIG. 5A is a diagram representing a large number of points on a surface of a structure as a three-dimensional point group. FIG. 5B is a diagram in which a captured image obtained by capturing a structure is texture-mapped on a multi-sided polygon.

FIG. 6 is a diagram showing an example of a plurality of types of data included in inspection data.

FIG. 7 is a diagram showing a template of inspection record data.

FIG. 8 is a diagram for describing a list display step and a selection reception step.

FIG. 9 is a diagram for describing an example of an information extraction step.

FIG. 10 is a diagram for describing another example of the information extraction step.

FIG. 11 is a diagram showing an example of a screen displayed on a display device in an extraction information display step.

FIG. 12 is a diagram showing another example of the screen displayed on the display device in the extraction information display step.

FIG. 13 is a diagram for describing another first aspect of the selection reception step, the information extraction step, and the extraction information display step.

FIG. 14 is a diagram for describing another second aspect of the selection reception step, the information extraction step, and the extraction information display step.

FIG. 15 is a diagram for describing another third aspect of the selection reception step, the information extraction step, and the extraction information display step.

### DESCRIPTION OF THE PREFERRED EMBODIMENTS

Hereinafter, preferred embodiments of an inspection support device for a structure, an inspection support method for a structure, and a program according to one aspect of the present invention will be described with reference to accompanying drawings. Here, the “structure” includes a construction, for example, a civil-engineering structure such as a bridge, a tunnel, or a dam, and also includes an architectural structure such as a building, a house, or a wall, pillar, or beam of a building.

[Hardware Configuration of Inspection Support Device for Structure]

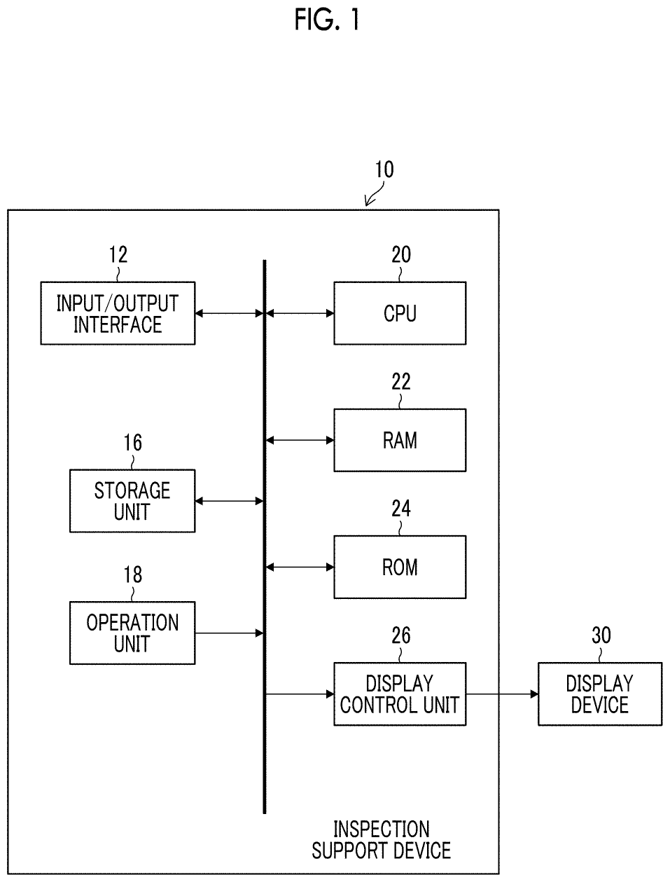

FIG. 1 is a block diagram showing an example of a hardware configuration of an inspection support device for a structure according to an aspect of the present invention.

As an inspection support device 10 for a structure shown in FIG. 1, a computer or a workstation can be used. The inspection support device 10 for the structure of the present example is mainly configured of an input/output interface 12, a storage unit 16, an operation unit 18, a central processing unit (CPU) 20, a random access memory (RAM) 22, a read only memory (ROM) 24, and a display control unit 26. A display device 30 is connected to the inspection support device 10 for the structure, and a display is performed on the display device 30 by control of the display control unit 26 under a command of the CPU 20. The display device 30 is configured of, for example, a monitor.

With the input/output interface 12, various pieces of data (information) can be input to the inspection support device 10 for the structure. For example, data stored in the storage unit 16 is input via the input/output interface 12.

The CPU (processor) 20 reads out various programs stored in the storage unit 16, the ROM 24, or the like, expands the programs in the RAM 22, and performs calculations to integrally control each unit. Further, the CPU 20 reads out a program stored in the storage unit 16 or the ROM 24 and performs a calculation using the RAM 22 to perform various types of processing of the inspection support device 10 for the structure.

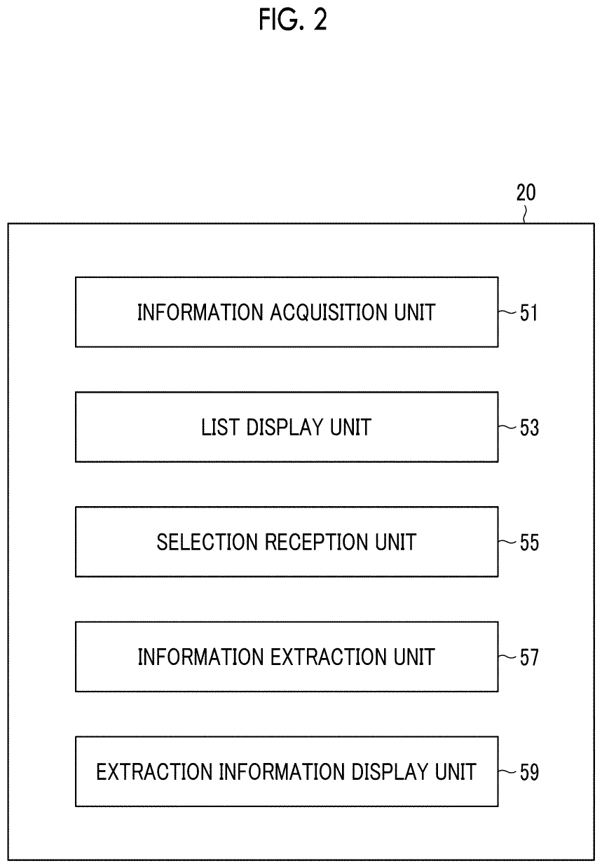

FIG. 2 is a block diagram showing a processing function realized by the CPU 20.

The CPU 20 has an information acquisition unit 51, a list display unit 53, a selection reception unit 55, an information extraction unit 57, and an extraction information display unit 59. A specific processing function of each unit will be described below. The information acquisition unit 51, the list display unit 53, the selection reception unit 55, the information extraction unit 57, and the extraction information display unit 59 are a part of the CPU 20, and thus it can also be said that the CPU 20 executes the processing of each unit.

Returning to FIG. 1, the storage unit (memory) 16 is a memory configured of a hard disk apparatus, a flash memory, and the like. The storage unit 16 stores data and a program for operating the inspection support device 10 for the structure, such as an operating system and a program for executing the inspection support method for the structure. Further, the storage unit 16 stores information and the like used in the present embodiment described below. The program for operating the inspection support device 10 for the structure may be recorded on an external recording medium (not shown), distributed, and installed by the CPU 20 from the recording medium. Alternatively, the program for operating the inspection support device 10 for the structure may be stored in a server or the like connected to a network in a state accessible from the outside and downloaded to the storage unit 16 by the CPU 20 in response to a request to be installed and executed.

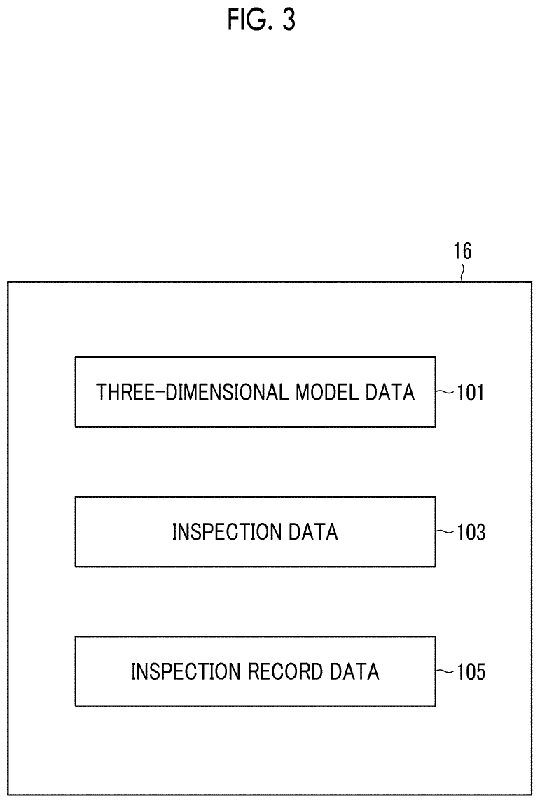

FIG. 3 is a diagram showing the information and the like stored in the storage unit 16. The storage unit 16 is configured of a non-temporary recording medium, such as a compact disk (CD), a digital versatile disk (DVD), a hard disk, or various semiconductor memories, and a control unit thereof.

The storage unit 16 mainly stores three-dimensional model data 101, inspection data 103, and inspection record data 105.

The three-dimensional model data 101 is, for example, data of a three-dimensional model of a structure created based on a plurality of captured images. The three-dimensional model data 101 includes data of a member region constituting the structure and a member name, and each member region and the member name are specified in the three-dimensional model data 101. The member region and the member name are specified for the three-dimensional model data 101, for example, based on a user operation. Further, the member region and the member name are automatically specified for the three-dimensional model data 101 from information about a shape, dimension, and the like of the member.

The inspection data 103 can include a plurality of types of data necessary for inspection. The inspection data 103 can include, for example, a captured image, a panoramic composite image, damage information, and a two-dimensional drawing. The captured image is a plurality of images obtained by capturing a structure, and the panoramic composite image is (a set of) images corresponding to a specific member, which are combined from the captured image. The two-dimensional drawing can include a general diagram, a damage diagram, a repair diagram, and the like. In a case where the structure is damaged, the captured image includes the damage. Thus, the damage can be extracted from the captured image. Further, the damage diagram and the repair diagram are automatically created from the extracted damage. The three-dimensional model data 101 and the inspection data 103 are associated with each other. For example, the inspection data 103 is stored in association with a position on the three-dimensional model data 101, a member, and the like. With designation of the position information on the three-dimensional model data 101, the inspection data 103 can be displayed. Further, with designation of the inspection data 103, the three-dimensional model data 101 can be displayed.

The inspection record data 105 is an example of a list of text data of a plurality of inspection points related to an inspection work of the structure. The list of text data is data created by a user (for example, a diagnostician) inputting a plurality of pieces of text data at predetermined positions in a template (document file having a designated format). The template may be in a format specified by Ministry of Land, Infrastructure, Transport and Tourism or a local government. The list of text data preferably includes text data such as findings described by a user (for example, a diagnostician).

The operation unit 18 shown in FIG. 1 includes a keyboard and a mouse, and a user can cause the inspection support device 10 to perform necessary processing via these devices. With use of a touch-panel type device, the display device 30 can function as an operation unit.

The display device 30 is a device such as a liquid crystal display and can display the three-dimensional model data 101, the inspection data 103, and the inspection record data 105.

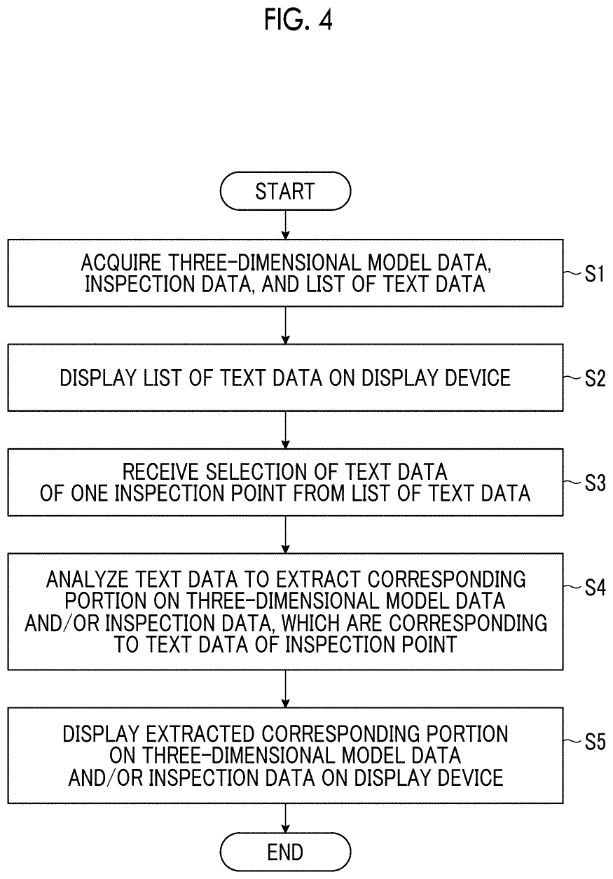

FIG. 4 is a flowchart showing an inspection support method for a structure with use of the inspection support device for a structure.

First, the information acquisition unit 51 acquires the three-dimensional model data 101, inspection data 103 mutually associated with the three-dimensional model data 101, and list of text data of the structure (information acquisition step: step S1). In the present example, the list of text data is the inspection record data 105.

Next, the list display unit 53 displays the acquired inspection record data 105 on the display device 30 (list display step: step S2). Next, the selection reception unit 55 receives selection of the text data of at least one inspection point from the displayed inspection record data 105 (selection reception step: step S3). Next, the information extraction unit 57 analyzes the selected text data to extract a corresponding portion on the three-dimensional model data 101 and/or the inspection data 103, which are corresponding to the text data of the inspection point (information extraction step: step S4). Next, the extraction information display unit 59 displays the extracted corresponding portion on the three-dimensional model data 101 and/or the extracted inspection data 103 on the display device 30 (extraction information display step: step S5). Each step will be described below.

<Information Acquisition Step>

The information acquisition step (step S1) is executed by the information acquisition unit 51. The information acquisition unit 51 acquires the three-dimensional model data 101, inspection data 103, and inspection record data 105 of the structure stored in the storage unit 16. In a case where the three-dimensional model data 101, the inspection data 103, and the inspection record data 105 are not stored in the storage unit 16, the information acquisition unit 51 acquires the three-dimensional model data 101, the inspection data 103, and the inspection record data 105 from the outside. For example, the information acquisition unit 51 acquires the three-dimensional model data 101, the inspection data 103, and the inspection record data 105 through the network via the input/output interface 12.

As camera parameters (focal length, image size and pixel pitch of image sensor, and the like) necessary for applying a structure from motion (SfM) method, parameters stored in the storage unit 16 can be used. Further, since an absolute scale cannot be obtained by the SfM method, the absolute scale (three-dimensional position) can be obtained with instruction of a known size (distance between two points or the like) of the structure, for example.

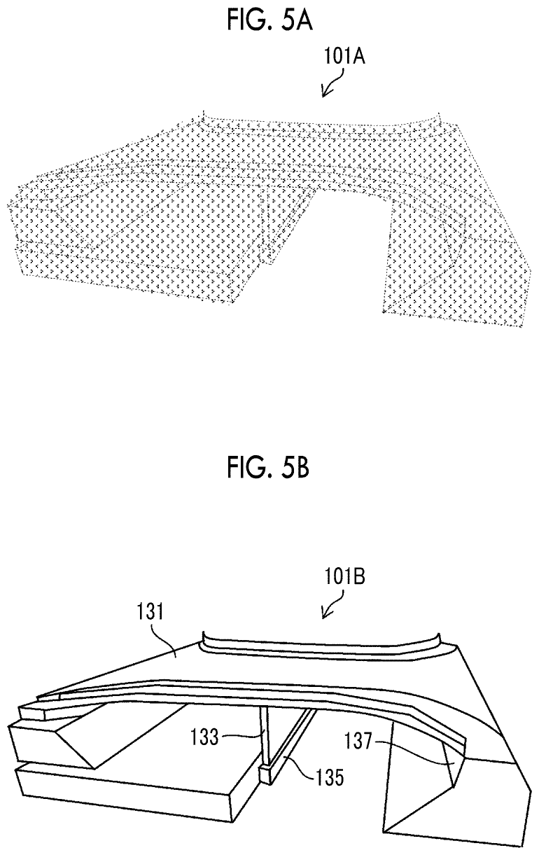

FIGS. 5A and 5B are diagrams showing an example of the three-dimensional model data 101. The three-dimensional model data 101 can be displayed as a point group, a polygon (mesh), a solid model, or the like. Three-dimensional model data 101A of FIG. 5A is a diagram representing a large number of points on a surface of the structure as a three-dimensional point group. The surface of the structure can be represented by an aggregate of multi-sided polygons (for example, triangular patches) based on the three-dimensional point group. Further, three-dimensional model data 101B of FIG. 5B is a diagram in which a captured image (texture) obtained by capturing the structure is texture-mapped on a multi-sided polygon. The three-dimensional model data 101 is not particularly limited.

In the example of FIG. 5B, the three-dimensional model data 101B includes the member name and the member region. The three-dimensional model data 101B is configured of, for example, a deck slab 131, a wall portion 133, a leg portion 135, and a solid wall 137.

Hereinafter, the three-dimensional model data 101A and the three-dimensional model data 101B may be referred to as the three-dimensional model data 101 without distinguishing between the data 101A and the data 101B.

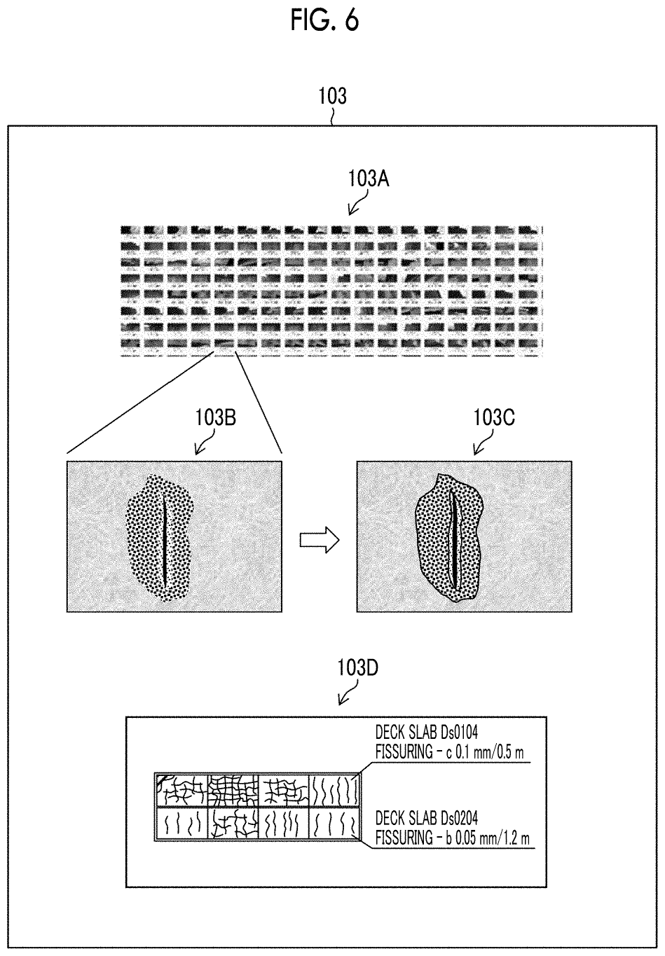

FIG. 6 is a diagram showing an example of the plurality of types of data included in the inspection data 103. The inspection data 103 includes a captured image group 103A configured of a plurality of captured images obtained by capturing a plurality of points of the structure. As an example of a captured image 103B constituting the captured image group 103A, a captured image including damage can be exemplified. With detection of the damage from the captured image 103B, a damage detection result image 103C is created. A method of expressing damage according to a type of damage is applied to the damage detection result image 103C. In the damage detection result image 103C, peeling and reinforcing bar exposure detected in the captured image 103B are represented by a drawing pattern by a closed line (polygon) surrounding a region of planar damage.

The inspection data 103 includes, for example, a damage diagram 103D. In the damage diagram 103D, for example, for each piece of damage generated in a deck slab of a bridge to be inspected, damage display (fissuring display, water leakage display, liberate lime display, or the like), a member name (“deck slab” or the like), an element number, a type of damage (“fissuring”, “water leakage”, “liberate lime”, or the like), and evaluation classification (rank information) of a degree of damage are described for each panel coffer.

The captured image 103B, the damage detection result image 103C, and the damage diagram 103D of FIG. 6 are examples and are not particularly limited to the displayed image. Each image may be described as the captured image 103B, the damage detection result image 103C, and the damage diagram 103D without being limited to the image displayed in FIG. 6.

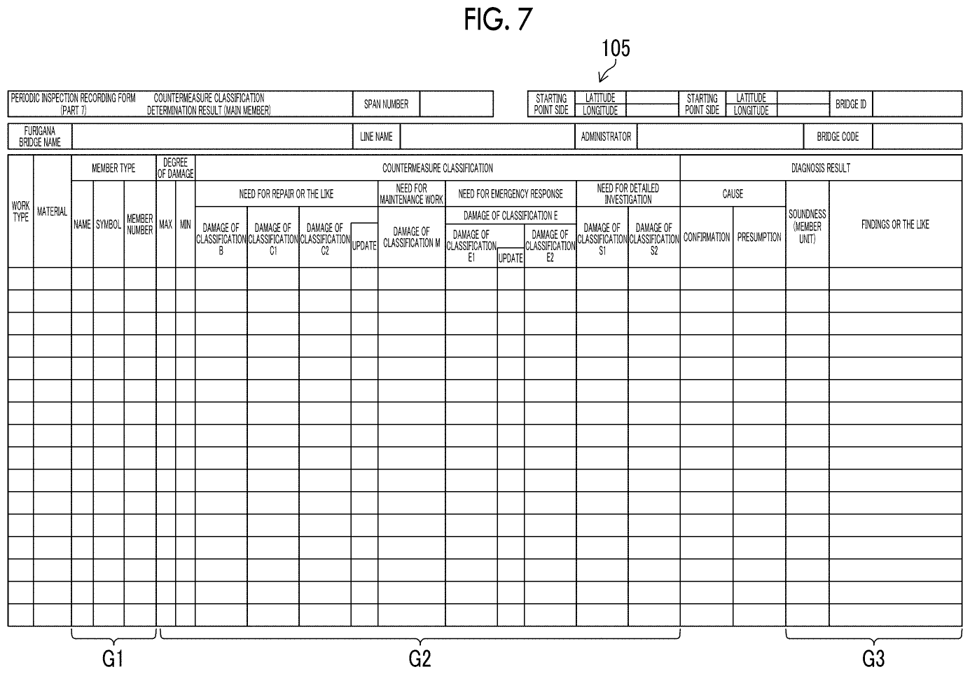

FIG. 7 is a diagram showing an example of a template of the inspection record data 105. The template inspection record data 105 indicates a state in which no text data is input. In the inspection record data 105, text data corresponding to a material name (material title), a symbol, a member symbol, a degree of damage, a need for repair, a need for detailed investigation, a cause, findings, and the like are input. The text data may be automatically input based on inspection data damage information or the like, or may be input based on a user operation. Text data of member information is mainly input to column G1, text data of damage information (type, degree, or the like) is mainly input to column G2, and text data of information about a position of damage and findings on damage situation (size, progressiveness, or the like) is mainly input to column G3.

<List Display Step and Selection Reception Step>

The list display step (step S2) is executed by the list display unit 53, and the selection reception step (step S3) is executed by the selection reception unit 55.

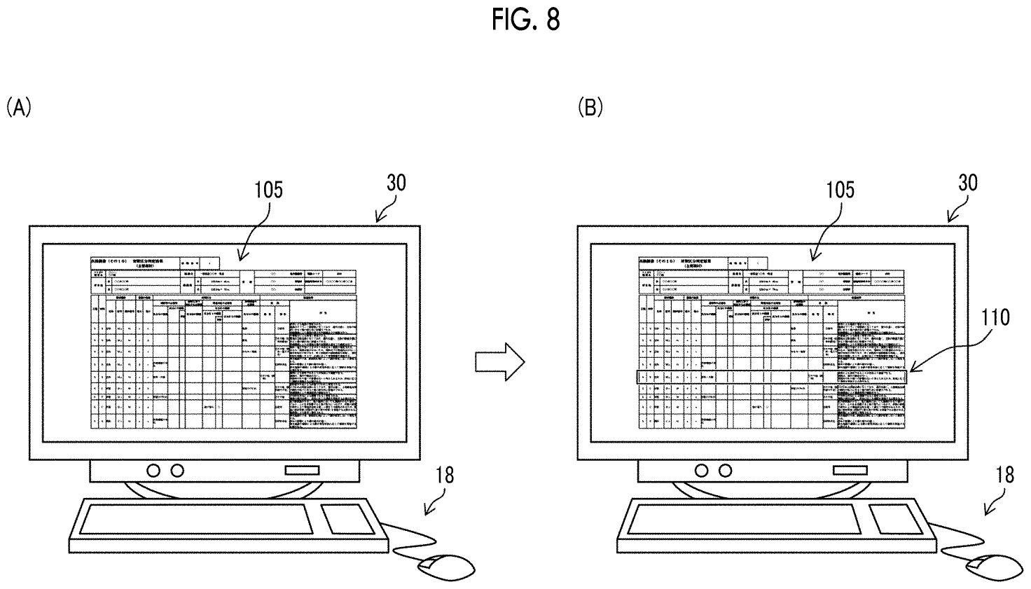

FIG. 8 is a diagram for describing the list display step and the selection reception step.

(A) of FIG. 8 is a diagram showing the inspection record data 105 displayed on the display device 30. The text data is input to the inspection record data 105, and the inspection record data 105 constitutes the list of text data. The inspection record data 105 of (A) of FIG. 8 is an example of the list of text data, and the format thereof is not particularly limited.

(B) of FIG. 8 is a diagram for describing a case where the selection of the text data of at least one inspection point is received from the inspection record data 105. The user manually selects a row that is determined to require a check, on the inspection record data 105 via the operation unit 18. With this operation, the text data of the inspection point is selected. In (B) of FIG. 8, the selected text data of the inspection point is surrounded by a black frame 110. The selection reception unit 55 receives the selected text data. Although not shown in (B) of FIG. 8, in the selection reception step (step S3), the selection reception unit 55 can receive selection of text data of a plurality of inspection points.

<Information Extraction Step>

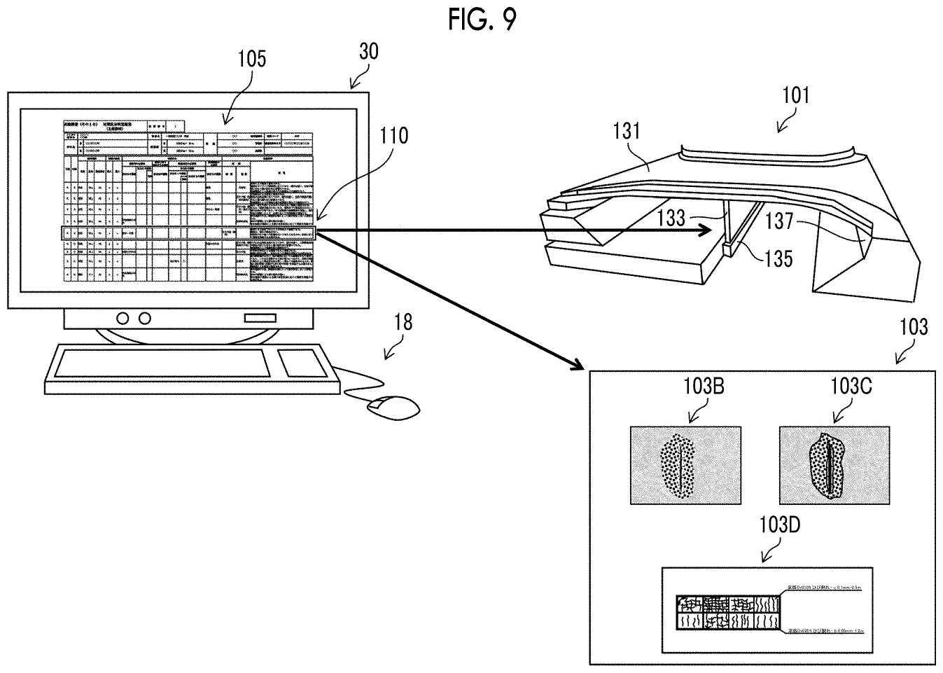

Next, the information extraction step (step S4) is executed by the information extraction unit 57. FIG. 9 is a diagram for describing an example of the information extraction step.

The information extraction unit 57 (refer to FIG. 2) analyzes the text data received by the selection reception unit 55 (refer to FIG. 2). The information extraction unit 57 determines from the text data of the inspection record data 105 and the input columns G1 to G3 whether the text data is any information of the member information, the damage information, the position of damage, and the like.

As shown in FIG. 9, the information extraction unit 57 specifies the member, the position, and the damage from the text data. The information extraction unit 57 extracts the corresponding portion on the three-dimensional model data 101 and/or the inspection data 103, which are corresponding to this text data, based on the information of the member, the position, and the damage.

The information extraction unit 57 extracts the damage diagram (member unit of deck slab, bridge, or the like) that is the two-dimensional drawing, the panoramic composite image (member unit of deck slab, bridge, or the like), the damage information (type, degree, size, or the like of damage), the captured image, and the like, which are included in the inspection data 103.

The information extraction unit 57 can execute not only the extraction of the information based on the text data but also the extraction of the information by a user operation.

In FIG. 9, the information extraction unit 57 directly extracts the corresponding portion on the three-dimensional model data 101 and/or the inspection data 103.

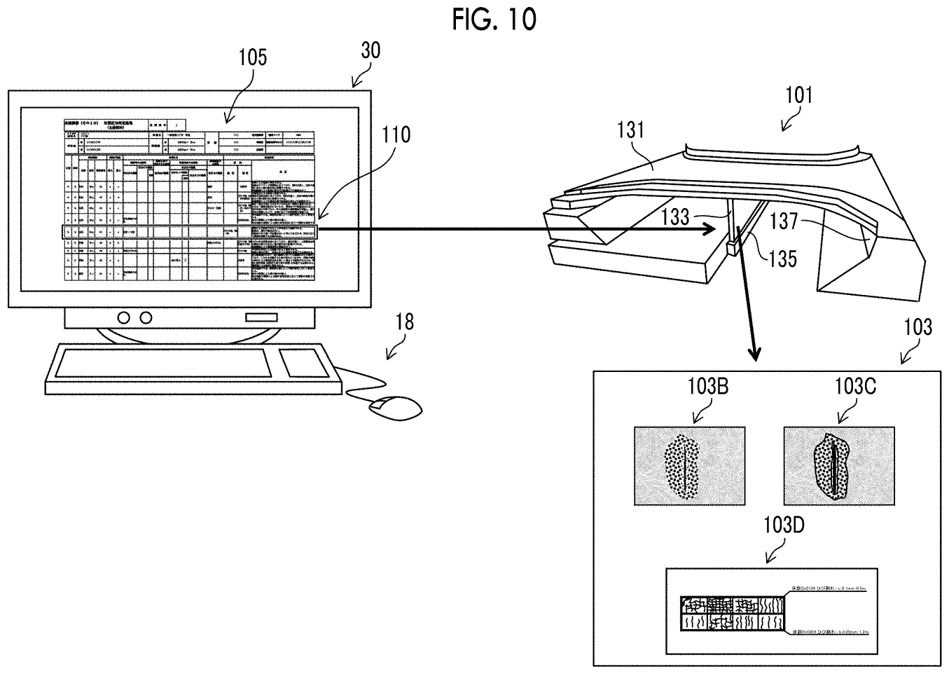

FIG. 10 is a diagram for describing another example of the information extraction step. The information extraction unit 57 (refer to FIG. 2) analyzes the text data received by the selection reception unit 55 (refer to FIG. 2). The information extraction unit 57 determines from the text data of the inspection record data 105 and the input columns G1 to G3 whether the text data is any information of the member information, the damage information, the position of damage, and the like. As a method of analyzing the text data, for example, named entity recognition (NER) can be used. The named entity recognition is a technique of recognizing a noun, an adjective, a verb, and the like that appear in the text data. For example, the named entity in the inspection record data is a noun, an adjective, a verb, or the like representing a type of member, a type of damage, a position of damage, progressiveness of damage, or the like. The named entity may be recognized on a rule basis by a dictionary, or may be recognized by artificial intelligence (AI) that learns the text data of the inspection record data. However, the method of analyzing the text data is not limited to the above method.

As shown in FIG. 10, the information extraction unit 57 specifies the member, the position, and the damage from the text data. The information extraction unit 57 extracts the corresponding portion on the three-dimensional model data 101 corresponding to the text data based on the information of the member, the position, and the damage. The information extraction unit 57 extracts the inspection data 103 associated with the extracted corresponding portion on the three-dimensional model data 101. The information extraction unit 57 can extract the inspection data 103 based on extracted three-dimensional position information on the three-dimensional model data 101.

In another example of the information extraction step, the inspection data 103 is extracted via the three-dimensional model data 101. Even in a case where the inspection data 103 cannot be directly extracted, the information extraction unit 57 can indirectly extract the inspection data 103 via the three-dimensional model data 101. In a case where the text data of the plurality of inspection points is selected and received in the selection reception step (step S3), in the information extraction step, the information extraction unit 57 can extract a plurality of corresponding portions on the three-dimensional model data 101 and/or a plurality of pieces of inspection data 103, which are corresponding to the plurality of pieces of text data.

<Extraction Information Display Step>

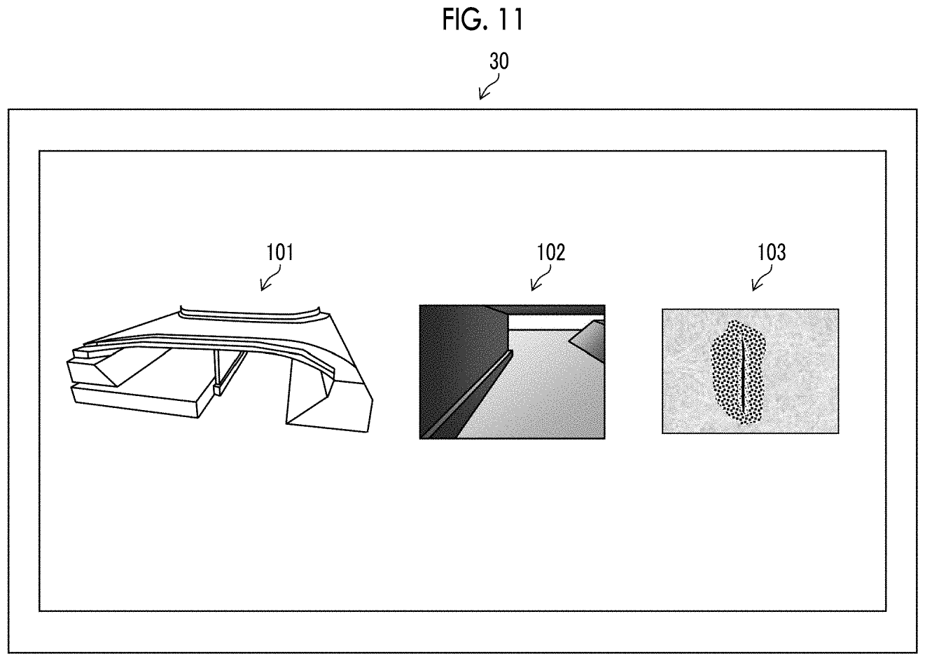

The extraction information display step (step S5) is executed by the extraction information display unit 59. The extraction information display unit 59 displays the information extracted by the information extraction unit 57 on the display device 30. FIG. 11 is a diagram showing an example of a display displayed on the display device 30 by the extraction information display unit 59 (refer to FIG. 2). As shown in FIG. 11, the display device 30 simultaneously displays the three-dimensional model data 101, a corresponding portion 102 on the three-dimensional model data 101, and the inspection data 103. In FIG. 11, the three-dimensional model data 101 is an overall bird's-eye view, the corresponding portion 102 is an enlarged view of a member, and the inspection data 103 is a captured image of a point of interest. Damage is captured in the captured image.

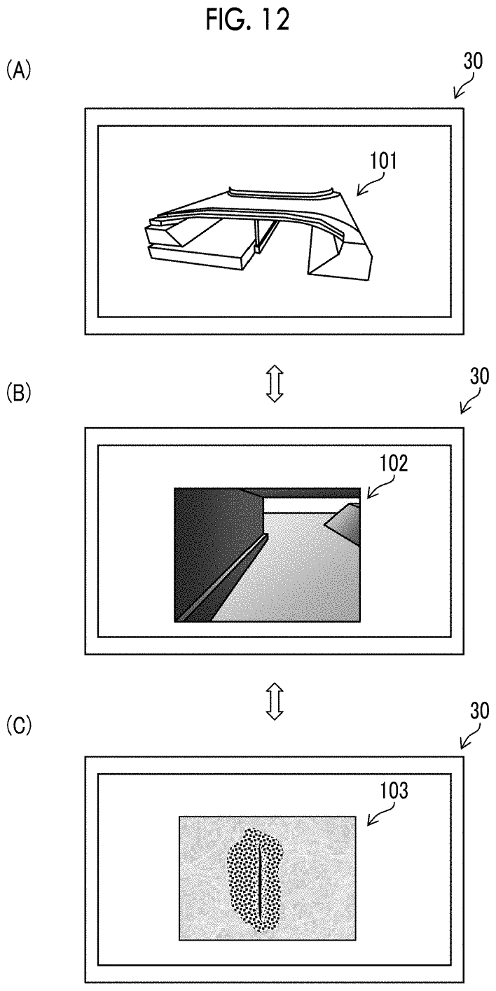

FIG. 12 is a diagram showing another example of the display displayed on the display device 30 by the extraction information display unit 59 (refer to FIG. 2). As shown in (A) of FIG. 12, only the three-dimensional model data 101 is displayed on the display device 30. As shown in (B) of FIG. 12, only the corresponding portion 102 on the three-dimensional model data 101 is displayed on the display device 30. As shown in (C) of FIG. 12, only the inspection data 103 is displayed on the display device 30.

As shown in FIG. 12, the display of the display device 30 can be gradually moved for enlargement from the display of the three-dimensional model data 101 ((A) of FIG. 12) showing the overall bird's-eye view to the display of the inspection data 103 ((C) of FIG. 12), which is the captured image of the point of interest, through the display of the corresponding portion 102 ((B) of FIG. 12) showing the enlarged view of the member. Further, the display of the display device 30 can be gradually moved for enlargement from the display of the inspection data 103 ((C) of FIG. 12) to the display of the three-dimensional model data 101 ((A) of FIG. 12) through the display of the corresponding portion 102 ((B) of FIG. 12).

The extraction information display unit 59 causes the display device 30 to display at least one type of data from the plurality of types of data (captured image, panoramic composite image, damage information, two-dimensional drawing, and the like) included in the inspection data 103.

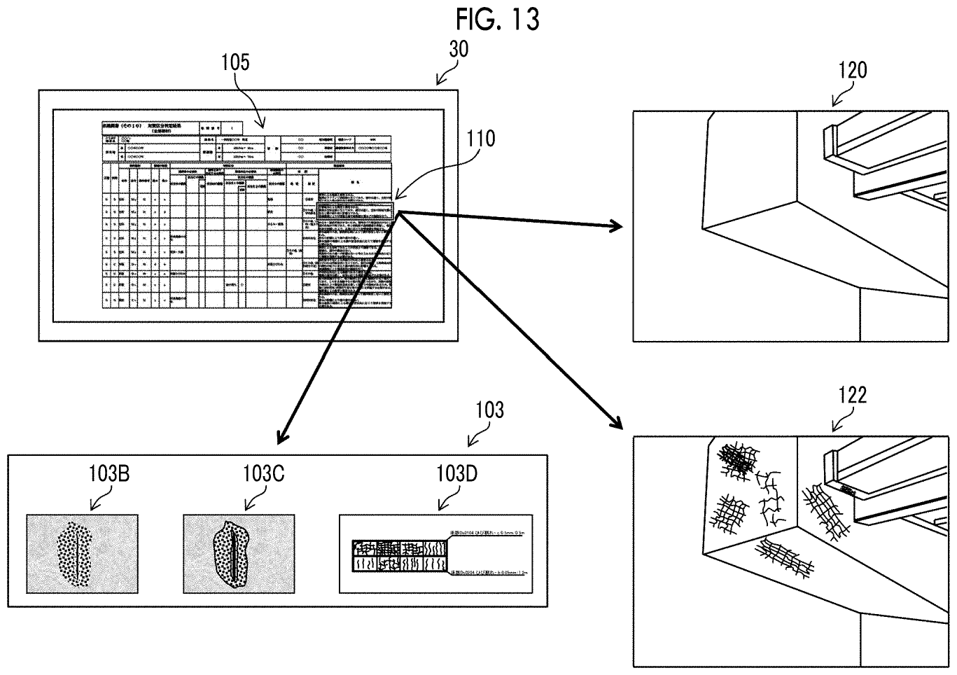

Next, another first aspect of the selection reception step, the information extraction step, and the extraction information display step will be described with reference to FIG. 13.

As shown in FIG. 13, the inspection record data 105 is displayed on the display device 30. The user manually selects a square (cell) that is determined to require a check, on the inspection record data 105 via the operation unit 18. In FIG. 13, a square surrounded by the black frame 110 includes the text data of the findings of the inspection record data 105. The selection reception unit 55 receives the selected text data (selection reception step).

The information extraction unit 57 (refer to FIG. 2) analyzes the text data received by the selection reception unit 55 (refer to FIG. 2).

The information extraction unit 57 individually extracts images and drawings corresponding to the captured image 103B, the damage detection result image 103C, the damage diagram 103D, and the like, as the inspection data 103 corresponding to the text data (information extraction step).

The extraction information display unit 59 individually displays, on the display device 30, the images and drawings of the inspection data 103 extracted by the information extraction unit 57 (refer to FIG. 1) (extraction information display step).

Further, the extraction information display unit 59 can display, as the inspection data 103, three-dimensional model data 120 to which the captured image 103B is mapped. Further, the extraction information display unit 59 can display, as the inspection data 103, three-dimensional model data 122 to which the captured image 103B and the damage detection result image 103C are mapped (extraction information display step).

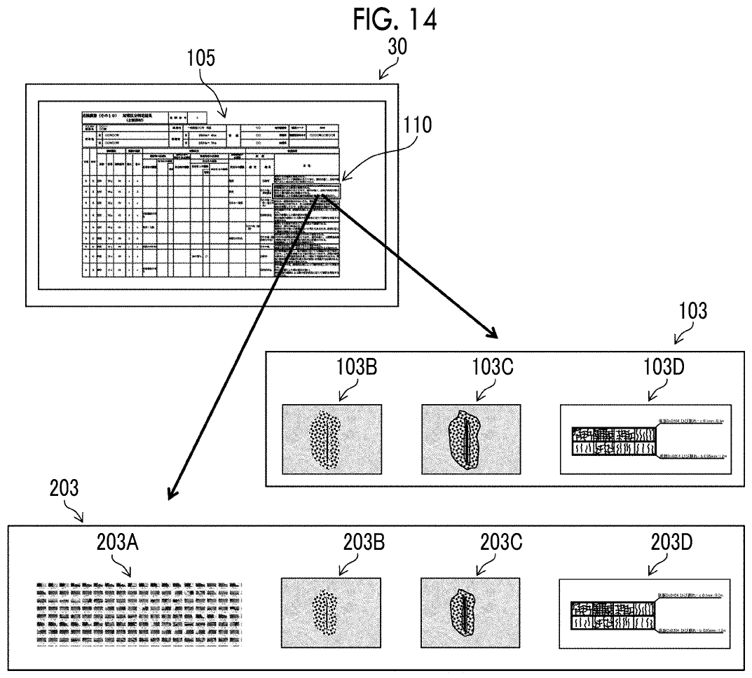

Another second aspect of the selection acceptance step, the information extraction step, and the extraction information display step will be described with reference to FIG. 14. Similarly to another first aspect, the selection reception unit 55 receives the text data of the selected square (portion surrounded by black frame 110) (selection reception step).

The information extraction unit 57 individually extracts images and drawings corresponding to the captured image 103B, the damage detection result image 103C, the damage diagram 103D, and the like, as the inspection data 103 corresponding to the text data (information extraction step). Further, in a case where the text data is analyzed and the text data related to the progressiveness of the damage is determined to be included, the information extraction unit 57 can extract past inspection data 203 corresponding to the inspection data 103 (information extraction step). The past inspection data 203 includes a past captured image group 203A, a past captured image 203B, a past damage detection result image 203C, a past damage diagram 203D, and the like. The past inspection data 203 can be stored in the storage unit 16 or an external storage unit. As the text data relating to the progressiveness of the damage, for example, expressions such as “almost no progressing is seen”, “progressing is slow”, or “progressing is fast” can be exemplified.

The extraction information display unit 59 individually displays, on the display device 30, images and drawings of the inspection data 103 extracted by the information extraction unit 57 and the past inspection data 203 (refer to FIG. 1) (extraction information display step). With the display of the inspection data 103 and the past inspection data 203 on the display device 30 (refer to FIG. 1), the user can easily understand the progressing situation of the damage.

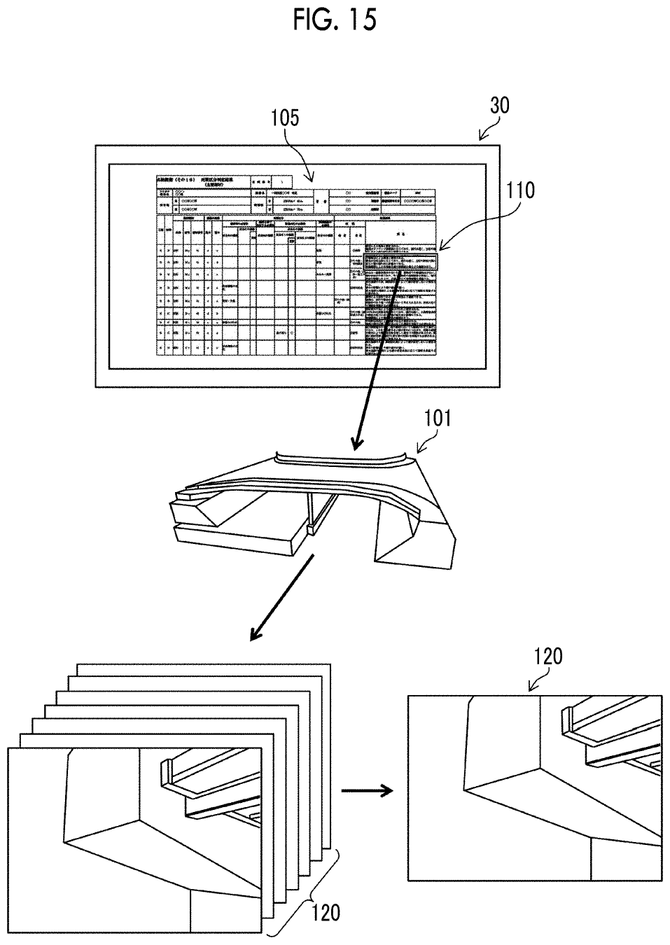

Another third aspect of the selection reception step, the information extraction step, and the extraction information display step will be described with reference to FIG. 15. Similarly to another first aspect, the selection reception unit 55 receives the text data of the selected square (selection reception step).

The information extraction unit 57 specifies the corresponding portion on the three-dimensional model data 101 corresponding to the text data. A plurality of captured images 103B (refer to FIG. 6) are extracted from the captured image group 103A of the inspection data 103 (refer to FIG. 6) based on positional information of corresponding portions on the three-dimensional model data 101 (information extraction step).

Each captured image 103B of the captured image group 103A has an overlapping region that overlaps with each other. Therefore, there are the plurality of captured images 103B corresponding to the positional information on the three-dimensional model data 101 in the captured image group 103A.

The extraction information display unit 59 displays mapped three-dimensional model data 120 satisfying a condition from a plurality of pieces of the three-dimensional model data 120 to which the captured image 103B is mapped, as the inspection data 103, which are display targets (extraction information display step). In the present example, it is shown that the mapped three-dimensional model data 120 satisfying the condition is displayed. Even in this case as well, there is a state in which the captured image 103B satisfying the condition is displayed from the plurality of captured images 103B.

Here, the condition may be randomly determined by the user or may be automatically determined by the user. For example, “normalization degree of captured image 103B” or “distance of the captured image 103B to structure” can be applied as the condition, and the extraction information display unit 59 can display the captured image 103B satisfying this condition from the plurality of captured images 103B.

As another condition, in the case of the captured image 103B including damage, “image quality is good” or “damage is at the center of captured image 103B” can be applied as the condition, and the extraction information display unit 59 can display the captured image 103B satisfying this condition from the plurality of captured images 103B.

The extraction information display unit 59 can display at least one of an optimum captured image 103B satisfying the condition or the damage detection result image 103C for the optimum captured image 103B.

As described above, the user can easily check the corresponding portion 102 of the three-dimensional model data 101, the inspection data 103, and the mapped three-dimensional model data 120 and 122 from the text data included in the inspection record data 105, which is the list of text data. In a case where the corresponding portion on the three-dimensional model data 101 and/or the inspection data 103, which are corresponding to the plurality of pieces of text data, are extracted in the information extraction step, in the extraction information display step (step S5), the extraction information display unit 59 can also display the plurality of inspection data 103 and the corresponding portion 102 of the three-dimensional model data 101 corresponding to each of the text data of the plurality of inspection points.

<Others>

In the above description, a form has been described in which the information acquisition unit 51 acquires the information stored in the storage unit 16, but the present invention is not limited thereto. For example, in a case where necessary information is not stored in the storage unit 16, the information acquisition unit 51 may acquire the information from the outside via the input/output interface 12. Specifically, the information acquisition unit 51 acquires the information input from the outside of the inspection support device 10 for the structure via the input/output interface 12.

In the above embodiment, a hardware structure of a processing unit that executes various types of processing is the following various processors. The various processors include a central processing unit (CPU) which is a general-purpose processor that executes software (program) to function as various processing units, a programmable logic device (PLD) which is a processor whose circuit configuration can be changed after manufacturing such as a field programmable gate array (FPGA), a dedicated electric circuit which is a processor having a circuit configuration specifically designed to execute specific processing such as an application specific integrated circuit (ASIC), and the like.

One processing unit may be configured of one of these various processors or may be configured of two or more processors of the same type or different types (for example, a plurality of FPGAs or a combination of CPU and FPGA). Further, a plurality of processing units can be configured by one processor. As an example of configuring the plurality of processing units by one processor, first, there is a form in which one processor is configured of a combination of one or more CPUs and software, as represented by a computer such as a client or a server, and the one processor functions as the plurality of processing units. Second, there is a form in which a processor that realizes the functions of the entire system including the plurality of processing units by one integrated circuit (IC) chip is used, as represented by a system on chip (SoC) or the like. As described above, the various processing units are configured by using one or more various processors as a hardware structure.

Further, as the hardware structure of the various processors, more specifically, an electric circuit (circuitry) in which circuit elements such as semiconductor elements are combined may be used.

Each of the above configurations and functions can be realized by any hardware, software, or a combination of both, as appropriate. For example, the present invention can be also applied to a program causing a computer to execute the above processing step (processing procedure), a computer-readable recording medium (non-temporary recording medium) on which such a program is recorded, or a computer on which such a program can be installed.

Although the examples of the present invention have been described above, it is needless to say that the present invention is not limited to the embodiments described above and various modifications can be made within a range not departing from the spirit of the present invention.

### EXPLANATION OF REFERENCES

10: inspection support device
12: input/output interface
16: storage unit
18: operation unit
20: CPU
22: RAM
24: ROM
26: display control unit
30: display device
51: information acquisition unit
53: list display unit
55: selection reception unit
57: information extraction unit
59: extraction information display unit
101: three-dimensional model data
101A: three-dimensional model data
101B: three-dimensional model data
102: corresponding portion
103: inspection data
103A: captured image group
103B: captured image
103C: damage detection result image
103D: damage diagram
105: inspection record data
110: black frame
120: three-dimensional model data
122: three-dimensional model data
131: deck slab
133: wall portion
135: leg portion
137: solid wall
203: inspection data
203A: captured image group
203B: captured image
203C: damage detection result image
203D: damage diagram

What is claimed is:

1. An inspection support device for a structure comprising:
a processor,
wherein the processor
acquires three-dimensional model data of the structure, inspection data mutually associated with the three-dimensional model data, and a list of text data of a plurality of inspection points related to an inspection work of the structure,
displays the list of text data on a display device,
receives selection of the text data of at least one inspection point from the displayed list of text data,
analyzes the selected text data to extract a corresponding portion on the three-dimensional model data and/or the inspection data, which are corresponding to the text data of the inspection point, and
displays the extracted corresponding portion on the three-dimensional model data and/or the extracted inspection data on the display device.

2. The inspection support device for a structure according to claim 1,
wherein the processor
analyzes the selected text data to extract the corresponding portion on the three-dimensional model data corresponding to the inspection point and
extracts the inspection data associated with the extracted corresponding portion on the three-dimensional model data.

3. The inspection support device for a structure according to claim 1, further comprising:
a memory that stores the three-dimensional model data, the inspection data mutually associated with the three-dimensional model data, and the list of text data,
wherein the processor acquires the three-dimensional model data, the inspection data, and the list of text data from the memory.

4. The inspection support device for a structure according to claim 1,
wherein the processor
maps the extracted inspection data to the three-dimensional model data and displays the mapped data on the display device.

5. The inspection support device for a structure according to claim 1,
wherein the list of text data is an inspection record.

6. The inspection support device for a structure according to claim 1,
wherein the three-dimensional model data includes at least a member region and data of a member.

7. The inspection support device for a structure according to claim 1,
wherein the inspection data includes a plurality of types of data.

8. The inspection support device for a structure according to claim 7,
wherein the plurality of types of data include a captured image, a panoramic composite image, damage information, and a two-dimensional drawing.

9. The inspection support device for a structure according to claim 7,
wherein the processor
displays at least one type of data on the display device from the plurality of types of data included in the inspection data.

10. The inspection support device for a structure according to claim 8,
wherein the inspection data includes a plurality of captured images, and
the processor
displays the captured image satisfying a condition on the display device from the plurality of captured images to be displayed.

11. The inspection support device for a structure according to claim 1,
wherein the processor
analyzes the selected text data to extract past inspection data corresponding to the inspection point, and
displays the extracted past inspection data on the display device.

12. An inspection support method for a structure with use of an inspection support device for a structure including a processor, the inspection support method for a structure comprising:
via the processor,
acquiring three-dimensional model data of the structure, inspection data mutually associated with the three-dimensional model data, and a list of text data of a plurality of inspection points related to an inspection work of the structure;
displaying the list of text data on a display device;
receiving selection of the text data of at least one inspection point from the displayed list of text data;
analyzing the selected text data to extract a corresponding portion on the three-dimensional model data and/or the inspection data, which are corresponding to the text data of the inspection point; and
displaying the extracted corresponding portion on the three-dimensional model data and/or the extracted inspection data on the display device.

13. A non-transitory, computer-readable tangible recording medium which records thereon a program for causing, when read by a computer, the computer to execute an inspection support method for a structure, the program causing the computer to execute:
acquiring three-dimensional model data of the structure, inspection data mutually associated with the three-dimensional model data, and a list of text data of a plurality of inspection points related to an inspection work of the structure;
displaying the list of text data on a display device;
receiving selection of the text data of at least one inspection point from the displayed list of text data;
analyzing the selected text data to extract a corresponding portion on the three-dimensional model data and/or the inspection data, which are corresponding to the text data of the inspection point; and
displaying the extracted corresponding portion on the three-dimensional model data and/or the extracted inspection data on the display device.
